(19) United States
(12) Patent Application Publication
(10) Pub. No.: US 2011/0064041 A1
(43) Pub. Date: Mar. 17, 2011

(54) Apparatus and Method for Allocation of Subcarriers in Clustered DFT-Spread-OFDM

(76) Inventors: Kari Juhani Hooli, Oulu (FI); Kari Pekka Pajukoski, Oulu (FI); Esa Tapani Tiirola, Kempele (FI)

(21) Appl. No.: 12/988,846

(22) PCT Filed: Mar. 31, 2009
(86) PCT No.: PCT/EP2009/053826

§ 371 Date: Nov. 4, 2010

(30) Foreign Application Priority Data
Apr. 22, 2008 (GB) 0807338.9

(51) Int. Cl. H04W 72/04

(52) U.S. Cl. 370/329

(57) ABSTRACT

Apparatus configured to receive a first signal including at least one frequency domain value; map the first signal to a second signal including at least two clusters, each cluster including a whole number multiple of a first number of sub-carrier values, wherein each first signal value is mapped to one of the at least two clusters and each of the at least one first signal values is mapped to a sub-carrier value of the one of the at least two clusters dependent on a cluster selection.

### BACKGROUND OF THE INVENTION

1. Field of the Invention

The present invention relates to an apparatus, and in particular to apparatus for providing a service in a communication system.

2. Description of Related Art

A communication device can be understood as a device provided with appropriate communication and control capabilities for enabling use thereof for communication with others parties. The communication may comprise, for example, communication of voice, electronic mail (email), text messages, data, multimedia and so on. A communication device typically enables a user of the device to receive and transmit communication via a communication system and can thus be used for accessing various service applications.

A communication system is a facility which facilitates the communication between two or more entities such as the communication devices, network entities and other nodes. A communication system may be provided by one or more interconnect networks. One or more gateway nodes may be provided for interconnecting various networks of the system. For example, a gateway node is typically provided between an access network and other communication networks, for example a core network and/or a data network.

An appropriate access system allows the communication device to access to the wider communication system. An access to the wider communications system may be provided by means of a fixed line or wireless communication interface, or a combination of these. Communication systems providing wireless access typically enable at least some mobility for the users thereof. Examples of these include wireless communications systems where the access is provided by means of an arrangement of cellular access networks. Other examples of wireless access technologies include different wireless local area networks (WLANs) and satellite based communication systems.

A wireless access system typically operates in accordance with a wireless standard and/or with a set of specifications which set out what the various elements of the system are permitted to do and how that should be achieved. For example, the standard or specification may define if the user, or more precisely user equipment, is provided with a circuit switched bearer or a packet switched bearer, or both. Communication protocols and/or parameters which should be used for the connection are also typically defined. For example, the manner in which communication should be implemented between the user equipment and the elements of the networks and their functions and responsibilities are typically defined by a predefined communication protocol.

In the cellular systems a network entity in the form of a base station provides a node for communication with mobile devices in one or more cells or sectors. It is noted that in certain systems a base station is called ‘Node B’. Typically the operation of a base station apparatus and other apparatus of an access system required for the communication is controlled by a particular control entity. The control entity is typically interconnected with other control entities of the particular communication network. Examples of cellular access systems include. Universal Terrestrial Radio Access Networks (UTRAN) and GSM (Global System for Mobile) EDGE (Enhanced Data for GSM Evolution) Radio Access Networks (GERAN).

A non-limiting example of another type of access architectures is a concept known as the Evolved Universal Terrestrial Radio Access (E-UTRA). This is also known as Long term Evolution UTRA or LTE. An Evolved Universal Terrestrial Radio Access Network (E-UTRAN) consists of E-UTRAN Node Bs (eNBs) which are configured to provide base station and control functionalities of the radio access network. The eNBs may provide E-UTRA features such as user plane radio link control/medium access control/physical layer protocol (RLC/MAC/PHY) and control plane radio resource control (RRC) protocol terminations towards the mobile devices.

In systems providing packet switched connections the access networks are connected to a packet switched core network via appropriate gateways. For example, the eNBs are connected to a packet data core network via an E-UTRAN access gateway (aGW)—these gateways are also known as service gateways (sGW) or mobility management entities (MME).

In current implementations of the long term evolution (LTE) of 3GPP the downlink access technique (from the base station to the user equipment) is provided by orthogonal frequency division multiplexing (OFDM), whereas the uplink access technique (from the user equipment to the base station) is based on single carrier frequency division multiple access (SC-FDMA).

There is currently much research on extending and optimising the 3GPP radio access technologies for local area (LA) access solutions in order to provide new services with high data rates and at very low cost. These research activities attempt to provide a local area optimised radio system which also fulfils the international telecommunication union—radio communication sector. (ITU-R) requirements for international mobile telecommunications—advanced standards (IMT).

The current standard (release 8 3GPP) differs from the competing radio access techniques such as WiMAX, IEEE 802,11, IEEE 802.20 in that the basic uplink transmissions scheme of the long term evolution (LTE) release 8 uses a low peak to average power ratio (PAPR) single carrier transmission such as single carrier frequency division multiple access (SC-FDMA) with cyclic prefix to achieve uplink inter-user orthogonality and to provide efficient frequency domain equalisation at the receiver side.

In the other systems described previously, such as WiMAX, IEEE 802.11, and IEEE 802.20, orthogonal frequency division multiple access (OFDMA) is used.

Typically SC-FDMA has an advantage over OFDMA in the low PAPR and low output back-off (OBO) of the user equipment transmitter. This advantage translates into an improved uplink coverage and/or a lower power consumption for the user equipment transmitter.

However the single carrier transmission techniques such as SC-FDMA have a series of disadvantages.

Firstly, the single carrier approaches known have constraints with regard to the flexibility of the adaptivity and scheduling of the frequency domain components.

Secondly, for both multiple input multiple output (MIMO) and single input multiple output (SIMO) transmissions the optimization of the reference signal structure in single carrier approaches is limited (compared to OFDMA). In other words the reference signals sent in different cells and within a cell have non-optimal cross-correlation properties and hence cause mutual interference.

Thirdly, the SC-FDMA techniques currently used do not provide any support for potential frequency division multiplexing between data and control for a single user equipment.

Furthermore OFDMA techniques, although providing a partial solution to the problems above, have as indicated above a high cubic metric value.

Furthermore the generalised multi-carrier approaches proposed have the disadvantage in that they lack flexible carrier organisation and scheduling.

### SUMMARY

Embodiments of the present invention aim to address one or at least partially mitigate the above problems.

There is provided according to a first aspect of the invention an apparatus configured to: receive a first signal comprising at least one frequency domain value; and map the first signal to a second signal comprising at least two clusters, each cluster comprising a whole number multiple of a first number of sub-carrier values, wherein each first signal value is mapped to one of the at least two clusters and each of the at least one first signal values is mapped to a sub-carrier value of the one of the at least two clusters dependent on a cluster selection.

The first number may be 12.

Each cluster may represent at group of contiguous subcarrier values.

The first number of sub-carrier values may occupy a 180 kHz bandwidth.

The second signal may comprise at least 3 clusters, wherein each first signal value is preferably mapped to at least two non-adjacent of the at least 3 clusters.

The second signal may comprise 180 clusters, wherein each first signal value is preferably mapped to at least-two non-adjacent of the at least 180 clusters, wherein the at least two non-adjacent clusters are preferably clusters near the periphery of the spectrum spanned by the whole of the cluster spectrum.

The apparatus is preferably further configured to receive a cluster allocation signal, and wherein the cluster selection is preferably dependent on the cluster allocation signal.

The cluster allocation signal preferably comprises at least one of: a total number of clusters, a cluster size; a cluster placement; at least one cluster allocated to the apparatus.

The cluster allocation is preferably dependent on at least one of: a channel type; a channel mix; a radio conditions; the number of apparatus.

The first signal preferably comprises a plurality of processed symbol values, wherein the process preferably comprises at least one of: a serial to parallel conversion; a time to frequency domain conversion.

The apparatus may be further configured to transform the second signal to a third signal, wherein the third signal is a time domain signal and all of the at least two clusters are transformed to form the third signal.

The apparatus may further be configured to transmit the third signal.

According to a second aspect of the invention there is provided apparatus configured to: map a first signal to a second signal comprising at least one frequency domain value, wherein the first signal comprises at least two clusters, at least one cluster comprising a whole number multiple of a first number of sub-carrier values, wherein the at least one cluster sub-carrier values are mapped to the at least one frequency domain values dependent on a cluster selection.

The first number is preferably 12.

Each cluster preferably represents at group of contiguous subcarrier values.

The first signal preferably comprises at least 3 clusters, wherein at least two non-adjacent cluster sub-carrier values are preferably mapped to the at least one frequency domain values.

The first signal may comprise 180 clusters, wherein at least two non-adjacent cluster sub-carrier values are preferably mapped to the at least one frequency domain values, and wherein the at least two non-adjacent clusters are preferably clusters near the periphery of the spectrum spanned by the whole of the cluster spectrum.

The apparatus is further preferably configured to determine a cluster allocation signal, and wherein the cluster selection is dependent on the cluster allocation signal.

The cluster allocation signal preferably comprises at least one of: a total number of clusters, a cluster size; a cluster placement; at least one cluster allocated to the first signal.

The cluster allocation signal is preferably dependent on at least one of: a channel type; a channel mix; and a radio condition.

The apparatus may be further configured to process the second signal, wherein the process is preferably configured to be at least one of: a serial to parallel conversion; a time to frequency domain conversion; a parallel to serial conversion; and a frequency to time domain conversion.

The apparatus may be further configured to receive a third signal, wherein the apparatus is preferably configured to transform the third signal to generate the first signal, wherein the third signal may be a time domain signal.

According to a third aspect of the invention there is provided an apparatus configured to: determine a cluster allocation signal, and transmit the cluster allocation signal to a further apparatus.

The cluster allocation signal may comprise at least one of: a total number of clusters; a cluster size; a cluster placement; and at least one cluster allocated to the first signal.

The cluster allocation signal is preferably dependent on at least one of: a type of communications channel from the further apparatus to the apparatus; a determination of the mixture of the data to be transmitted on a communications channel from the further apparatus to the apparatus; and a radio condition of a communications channel from the further apparatus to the apparatus.

According to a fourth aspect of the invention there is provided a method comprising: receiving a first signal comprising at least one frequency domain value; mapping the first signal to a second signal comprising at least two clusters, each cluster comprising a whole number multiple of a first number of sub-carrier values, wherein each first signal value is mapped to one of the at least two clusters and each of the at least one first signal values is mapped to a sub-carrier value of the one of the at least two clusters dependent on a cluster selection.

The first number is preferably 12.

Each cluster may represent at group of contiguous subcarrier values.

The first number of sub-carrier values may occupy a 180 kHz bandwidth.

The second signal may comprise at least 3 clusters, wherein each first signal value is preferably mapped to at least two non-adjacent of the at least 3 clusters.

The second signal may comprise 180 clusters, wherein each first signal value is preferably mapped to at least-two non-adjacent of the 180 clusters, and the at least two non-adjacent clusters are preferably clusters near the periphery of the spectrum spanned by the whole of the cluster spectrum.

The method may further comprise receiving a cluster allocation signal, and wherein the cluster selection is dependent on the cluster allocation signal.

The cluster allocation signal may comprise at least one of: a total number of clusters; a cluster size; a cluster placement; and at least one cluster allocated to the apparatus.

The cluster allocation is preferably dependent on at least one of: a channel type; a channel mix; a radio conditions; and the number of apparatus.

The first signal may comprise a plurality of processed symbol values, wherein the process preferably comprises at least one of: a serial to parallel conversion; and a time to frequency domain conversion.

The method may further comprise transforming the second signal to a third signal, wherein the third signal is preferably a time domain signal and all of the at least two clusters are preferably transformed to form the third signal.

The method may further comprise transmitting the third signal.

According to a fifth aspect of the invention there is provided a method comprising: mapping a first signal to a second signal comprising at least one frequency domain value, wherein the first signal comprises at least two clusters, at least one cluster comprising a whole number multiple of a first number of sub-carrier values, wherein the at least one cluster sub-carrier values are mapped to the at least one frequency domain values dependent on a cluster selection.

The first number is preferably 12.

Each cluster preferably represents at group of contiguous subcarrier values.

The first signal may comprise at least 3 clusters, wherein at least two non-adjacent cluster sub-carrier values are preferably mapped to the at least, one frequency domain values.

The first signal may comprise 180 clusters, wherein at least two non-adjacent cluster sub-carrier values are preferably mapped to the at least one frequency domain values, and wherein the at least two non-adjacent clusters are preferably clusters near the periphery of the spectrum spanned by the whole of the cluster spectrum.

The method may further comprise determining a cluster allocation signal, and wherein the cluster selection is dependent on the cluster allocation signal.

The cluster allocation signal may comprise at least one of: a total number of clusters; a cluster size; a cluster placement; at least one cluster allocated to the first signal.

The cluster allocation signal is preferably dependent on at least one of: a channel type; a channel mix; and a radio condition.

The method may further comprise processing the second signal, wherein the processing preferably comprises at least one of: a serial to parallel conversion; a time to frequency domain conversion; a parallel to serial conversion; and a frequency to time domain conversion.

The method may further comprise receiving a third signal, wherein the method may comprise transforming the third signal to generate the first signal, and wherein the third signal is preferably a time domain signal.

According to a sixth aspect of the invention there is provided a method comprising: determining a cluster allocation signal; and transmitting the cluster allocation signal to an apparatus.

The cluster allocation signal may comprise at least one of: a total number of clusters, a cluster size; a cluster placement; at least one cluster allocated to the first signal.

The cluster allocation signal is preferably dependent on at least one of: a type of communications channel from the further apparatus to the apparatus; a determination of the mixture of the data to be transmitted on a communications channel from the further apparatus to the apparatus; a radio condition of a communications channel from the further apparatus to the apparatus.

According to a seventh aspect of the invention there is provided a computer program product configured to perform a method comprising: receiving a first signal comprising at least one frequency domain value; mapping the first signal to a second signal comprising at least two clusters, each cluster comprising a whole number multiple of a first number of sub-carrier values, wherein each first signal value is mapped to one of the at least two clusters and each of the at least one first signal values is mapped to a sub-carrier value of the one of the at least two clusters dependent on a cluster selection.

According to a eighth aspect of the invention there is provided a computer program product configured to perform a method comprising: mapping a first signal to a second signal comprising at least one frequency domain value, wherein the first signal comprises at least two clusters, at least one cluster comprising a whole number multiple of a first number of sub-carrier values, wherein the at least one cluster sub-carrier values are mapped to the at least one frequency domain values dependent on a cluster selection.

According to a ninth aspect of the invention there is provided a computer program product configured to perform a method comprising: determining a cluster allocation signal, and transmitting the cluster allocation signal to an apparatus.

According to a tenth aspect of the invention there is provided an apparatus comprising: means for receiving a first signal comprising at least one frequency domain value; and means for mapping the first signal to a second signal comprising at least two clusters, each cluster comprising a whole number multiple of a first number of sub-carrier values, wherein each first signal value is mapped to one of the at least two clusters and each of the at least one first signal values is mapped to a sub-carrier value of the one of the at least two clusters dependent on a cluster selection.

According to an eleventh aspect of the invention there is provided apparatus comprising: means for mapping a first signal to a second signal comprising at least one frequency domain value, wherein the first signal comprises at least two clusters, at least one cluster comprising a whole number multiple of a first number of sub-carrier values, wherein the at least one cluster sub-carrier values are mapped to the at least one frequency domain values dependent on a cluster selection.

According to a twelfth aspect of the invention there is provided apparatus comprising: means for determining a cluster allocation signal, and means for transmitting the cluster allocation signal to an apparatus.

The apparatus indicated above may comprise a user equipment.

The apparatus indicated above may comprise at least one of: a base transceiver station (BTS) for providing access in a GSM network; a node B (node B) for providing access in a UTRA network; and an evolved node B (node) for providing access in an EUTRA network.

BRIEF DESCRIPTIONS OF THE DRAWINGS

For a better understanding of the present invention and how the same may be carried into effect, reference will now be made, by way of example only to the accompanying drawings in which:

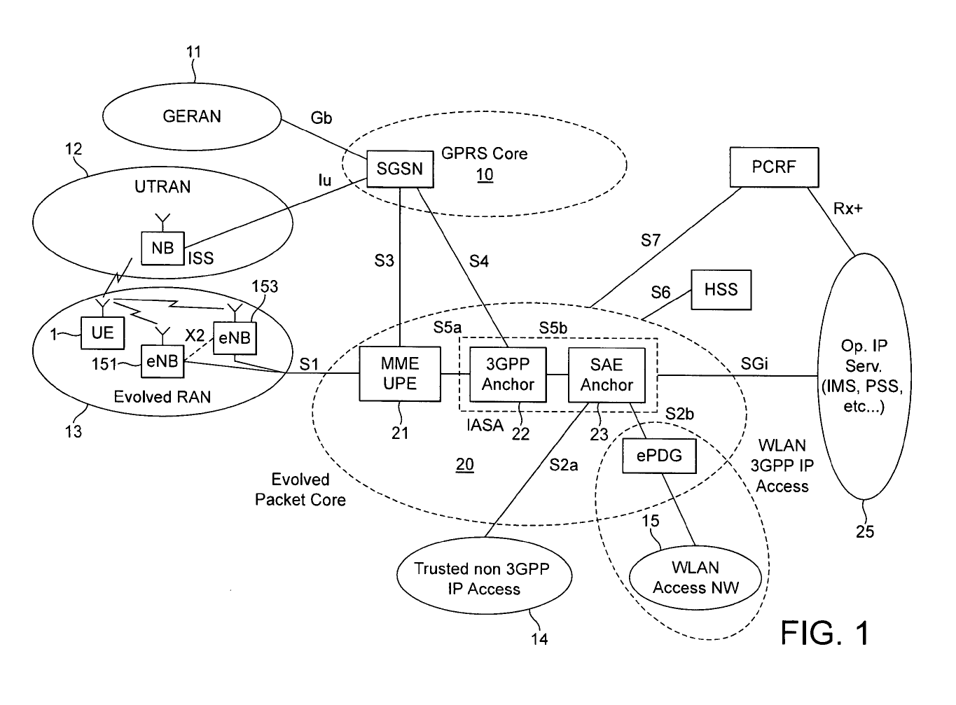

FIG. 1 shows a schematic presentation of a communication architecture wherein the invention may be embodied;

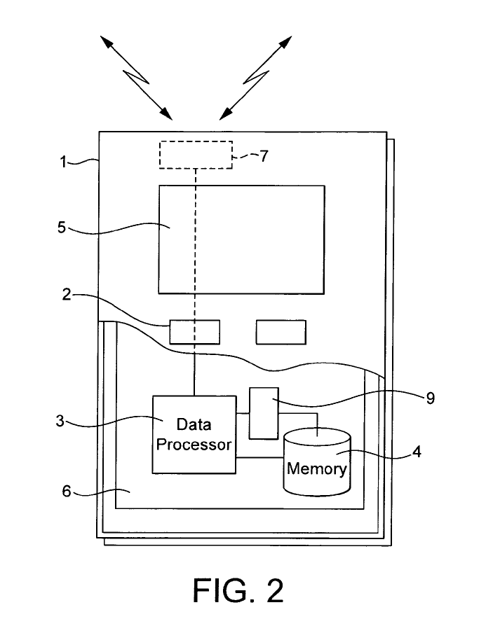

FIG. 2 shows a schematic presentation of an user equipment which may be operated in the communication architecture as shown in FIG. 1;

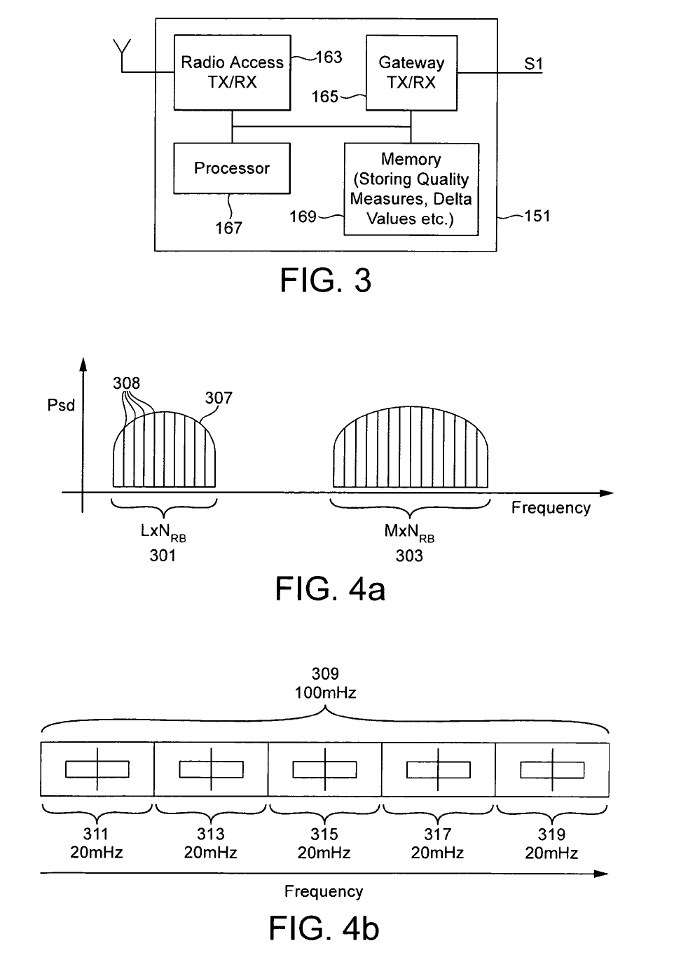

FIG. 3 shows a schematic presentation of an evolved node B which may be operated in the communication architecture as shown in FIG. 1;

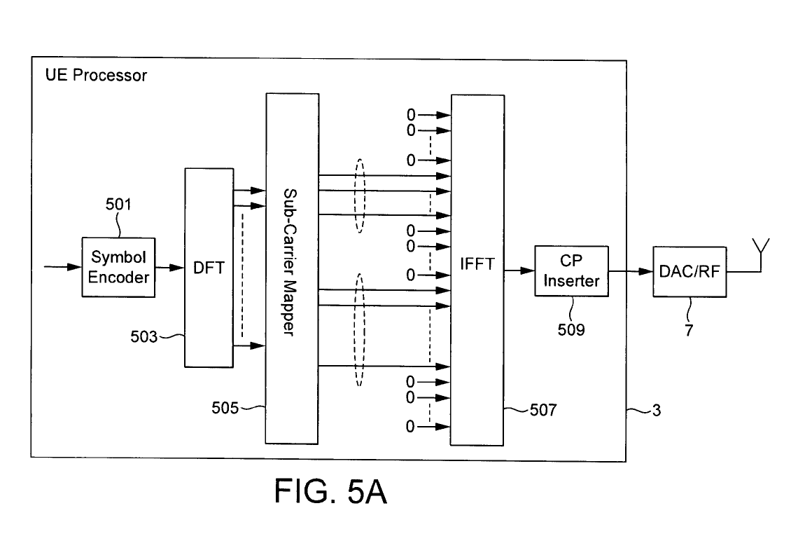

FIG. 4a shows a schematic presentation of a division of clusters/carriers according to an embodiment of the invention;

FIG. 4b shows a schematic presentation of a division of the spectrum according to an embodiment of the invention;

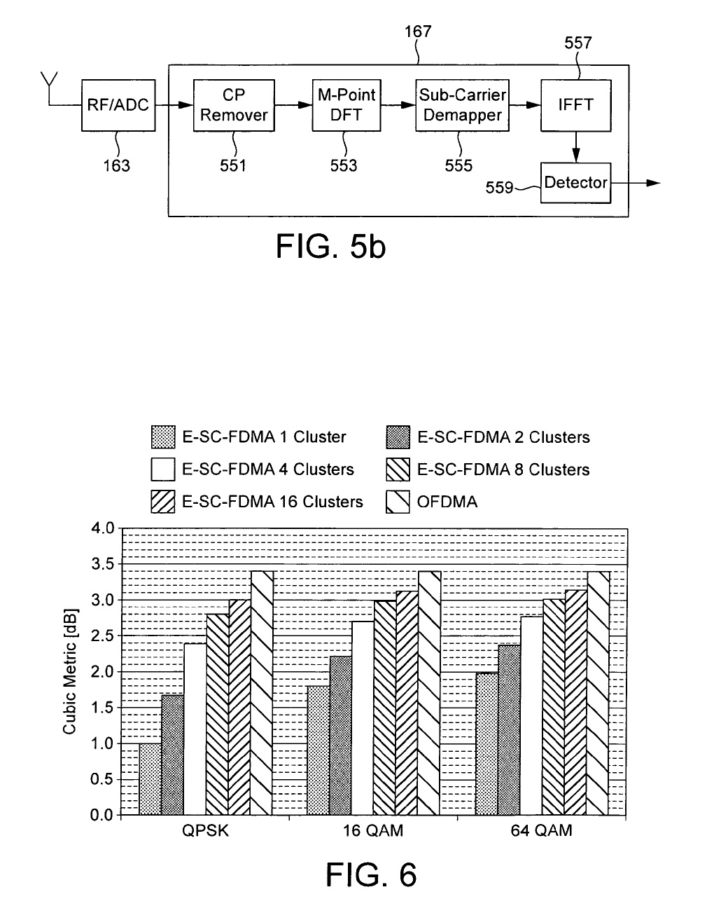

FIG. 5a shows a schematic presentation of a transmitter as implemented in embodiments of the invention shown in FIG. 1;

FIG. 5b shows a schematic presentation of a receiver as implemented in embodiments of the invention shown in FIG. 1;

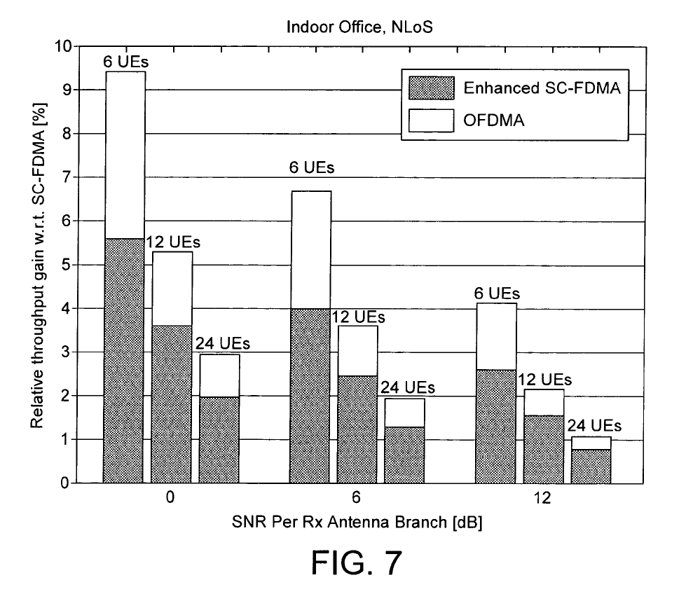

FIG. 6 shows a graph of a typical cubic metric score for embodiments of the invention shown in comparison with a orthogonal frequency division multiplexed system;

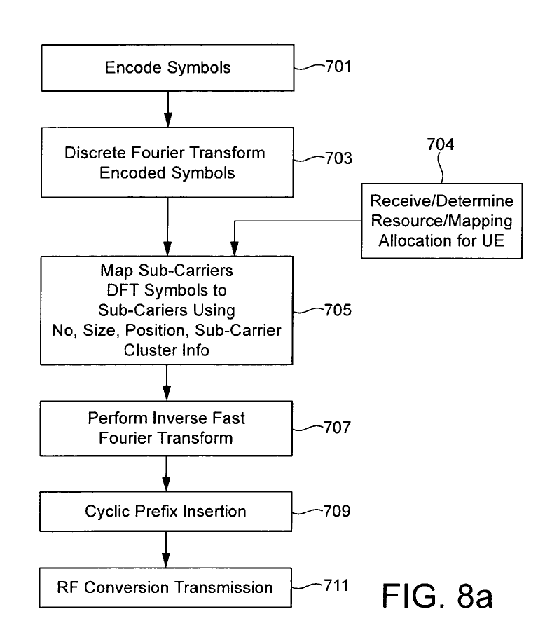

FIG. 7 shows a graph of a throughput comparison for an embodiment of the invention against a single channel frequency division multiplexed system;

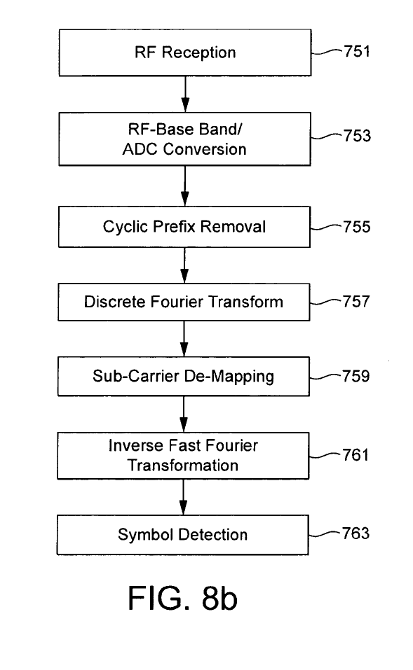

FIG. 8a shows a flow chart showing the operation of an embodiment of the invention as shown in FIG. 5a; and

FIG. 8b shows a flow chart showing the operation of an embodiment of the invention as shown in FIG. 5b.

### DESCRIPTION OF EXEMPLIFYING EMBODIMENTS

In the following certain specific embodiments are explained, with reference to standards such as Global System for Mobile (GSM) Phase 2, Code Division Multiple Access (CDMA) Universal Mobile Telecommunication System (UMTS) and long-term evolution (LTE). The standards may or not belong to a concept known as the system architecture evolution (SAE) architecture, the overall architecture thereof being shown in FIG. 1.

More particularly, FIG. 1 shows an example of how second generation (2G) access networks, third generation (3G) access networks and future access networks, referred to herein as long-term evolution (LTE) access networks are attached to a single data anchor (3GPP anchor). The anchor is used to anchor user data from 3GPP and non-3GPP networks. This enables adaptation of the herein described mechanism not only for all 3GPP network access but as well for non-3GPP networks.

In FIG. 1 two different types of radio access networks 11 and 12 are connected to a general packet radio service (GPRS) core network 10. The access network 11 is provided by a GERAN system and the access network 12 is provided by a UMTS terrestrial radio access (UTRAN) system. The UTRAN access network Ills provided by a series of UTRAN Node Bs of which one Node B NB 155 is shown. The core network 10 is further connected to a packet data system 20.

An evolved radio access system 13 is, also shown to be connected to the packet data system 20. Access system 13 may be provided, for example, based on architecture that is known from the E-UTRA and based on use of the E-UTRAN Node Bs (eNodeBs or eNBs) of which two eNBs 151 and 153 are shown in FIG. 1. The first eNB 151 is shown to be capable of communicating to the second eNB 153 via a X2 communication channel.

Access system 11, 12 and 13 may be connected to a mobile management entity 21 of the packet data system 20. These systems may also be connected to a 3GPP anchor node 22 which connects them further to a SAE anchor 23.

FIG. 1 shows further two access systems, that is a trusted non-3GPP IP (internet protocol) access system 14 and a WLAN access system 15. These are connected directly to the SAE anchor 23.

In FIG. 1 the service providers are connected to a service provider network system 25 connected to the anchor node system. The services may be provided in various manners, for example based on IP multimedia subsystem and so forth.

The various access networks may provide an overlapping coverage for suitable user equipment 1. For example the user equipment 1 as shown in FIG. 1 is shown being capable of communicating via the first eNB 151 in the EUTRA Network 13 and also the NB 155 of the UTRAN 12.

FIG. 2 shows a schematic partially sectioned view of a possible user equipment, also known as a mobile device 1 that can be used for accessing a communication system via a wireless interface provided via at least one of the access systems of FIG. 1. The user equipment (UE) of FIG. 2 can be used for various tasks such as making and receiving phone calls, for receiving and sending data from and to a data network and for experiencing, for example, multimedia or other content.

An appropriate user equipment may be provided by any device capable of at least sending or receiving radio signals. Non-limiting examples include a mobile station (MS), a portable computer provided with a wireless interface card or other wireless interface facility, personal data assistant (PDA) provided with wireless communication capabilities, or any combinations of these or the like. The mobile device may communicate via an appropriate radio interface arrangement of the mobile device. The interface arrangement may be provided for example by means of a radio part 7 and associated antenna arrangement. The antenna arrangement may be arranged internally or externally to the mobile device.

A user equipment is typically provided with at least one data processing entity 3 and at least one memory 4 for use in tasks it is designed to perform. The data processing and storage entities can be provided on an appropriate circuit board and/or in chipsets. This feature is denoted by reference 6.

The user may control the operation of the user equipment by means of a suitable user interface such as key pad 2, voice commands, touch sensitive screen or pad, combinations thereof or the like. A display 5, a speaker and a microphone are also typically provided. Furthermore, the user equipment may comprise appropriate connectors (either wired or wireless) to other devices and/or for connecting external accessories, for example hands-free equipment, thereto.

The user equipment 1 may be enabled to communicate with a number of access nodes, for example when it is located in the coverage areas of either of the access system stations 12 and 13 of FIG. 1.

FIG. 3 shows an example of an evolved node B (eNB) according to an embodiment of the present invention. The eNB 151 comprises a radio access transceiver 163, a gateway transceiver 165, a processor 167 and a memory 169.

Although the following describes the embodiment of the invention using evolved node B (eNB) apparatus operating within an EUTRAN, further embodiments of the invention may be performed in any base station, node B and evolved node B suitable for communicating with a user equipment capable of communication in that access network, and further comprising data processing and storage capacity suitable for carrying the operations as described below.

The radio access transceiver 163 receives from and transmits to a suitable user equipment data across the radio access network covered by the evolved node B 151.

The gateway transceiver 165 communicates to and from the gateway in the packet core which may be a mobility management entity (MME) or user plane entity (UPE) as shown in FIG. 1.

The processor 167 controls the radio access transceiver 163 and gateway transceiver 165 and furthermore carries out any additional processing tasks required by the eNB 151.

The memory 169 stores data required by the eNB 151. The data may comprise both parameter variables, and programs required by the processor, radio access transceiver 163, and gateway transceiver 165.

FIG. 4a shows a frequency spectrum of an enhanced single carrier frequency division multiple access (E-SC-FDMA) transmission according to an embodiment of the invention. The transmission as shown in FIG. 4 shows two separate clusters A cluster refers to a cluster of sub-carriers and also to a cluster of virtual sub-carriers. For example in OFDMA the term sub-carrier refers to the separate sub-carriers used for each orthogonal channel, whereas the term virtual sub-carrier is used in single carrier frequency division multiple access SC-FDMA systems as the signal is spread over multiple frequency pins. A pin is usually defined as a single IDFT input frequency value (that is, in case of, OFDMA, sub-carrier) generated by the use of the discrete fourier transform (OFT) block. A first cluster 301 and a second cluster 303. The first cluster 301 comprises L resource blocks and therefore has a cluster size of L×N_{rb} where N_{rb} is the resource block size in terms of the sub-carriers. The second resource block 303 has M number of resource blocks and therefore has a cluster size equal to M×N_{rb} sub-carriers. Furthermore FIG. 4 shows the individual resource blocks 307.

FIG. 4b shows the differences between the prior art frequency spectrum and the frequency spectrum as employed in embodiments of the invention. In the prior user equipment are each allocated onto a 20 MHz ‘chunk’ of the available spectrum. in FIG. 4b 5 of the 20 MHz ‘chunks’ are shown arranged side by side 311, 313, 315, 317, 319. In the present invention each user equipment is configured to transmit on the uplink to the base station using several or all of the ‘chunks’ at the same time. Thus a single user equipment according to embodiments of the invention may be assigned all five chunks, in other words a ‘wideband chunk’ 309 with a bandwidth of 100 MHz.

For example, in the prior art example of 3GPP LTE Release 8, the frequency spectrum is divided into resource blocks and the size of a resource block defined as 12 virtual sub-carriers. One or more adjacent resource blocks may be allocated to one user equipment according to the standard of LTE Release 8.

The user equipment according to embodiments of the invention may thus be assigned to the same 20 MHz chunk as user equipment specified according to LTE Release 8. This is because the cluster size of user equipment according to embodiments of the invention equals to a whole number of multiples of a resource block size defined in LTE Release 8.

With respect to FIG. 5a and FIG. 8a, an embodiment of the invention is described in further detail with respect to a transmitter on the uplink of a wireless communications channel. In other words FIGS. 5a and 8a describe the operation and apparatus of an user equipment for an embodiment of the invention. With respect to FIGS. 5b and 8b an embodiment of the invention is described in further detail with respect to a receiver on the uplink of a wireless communications channel, In other words FIGS. 5b and 8b describe the operation and apparatus of a base station such as an enhanced node B for an embodiment of the invention.

FIG. 5a in particular shows a schematic view of a series of functional blocks used in embodiments of the invention. The functional blocks described below may be implemented for example within a data processor 3 of user equipment 1 such as the user equipment as shown in FIG. 2. It would be understood that the functional blocks may be implemented as discrete functional units within the user equipment or enhanced node B in further embodiments of the invention.

The symbol encoder 501, which may also be known as a modulation mapper, receives a data input, which may be a sequence of scrambled bit values, to be transmitted and encodes the data sequence into a plurality of symbols, which may be a complex values symbol, dependent on the modulation scheme to be employed. For example, the modulation scheme may be a phase shift keying (PSK) based modulation scheme such as a quadrature phase shift keying (QPSK) operation. In other embodiments of the invention, the modulation may be an amplitude modulation scheme such as 16-QAM or 64-QAM. The symbol encoding process is shown in step 701 of FIG. 8a.

The symbol encoder 501 outputs the encoded symbols to the discrete fourier transformer 503.

The discrete fourier transformer (DFT) 503 receives the encoded symbols from the symbol encoder and converts the time domain symbol representation to a frequency domain representation. In other words the discrete fourier transformer 503 outputs a series of values representing the energy of the symbols for a series of frequency ranges. The discrete fourier transform may be implemented with any suitable transform operation, such as fast fourier transformer for example. The time to frequency domain transformation of the encoded symbols is shown in FIG. 8 by step 703.

In further embodiments of the invention, any suitable time to frequency domain transformation process may be employed in place of the discrete fourier transformer shown in FIG. 5a and FIG. 8a.

Although with respect to figured 5a and 8a we describe the implementation of the invention with respect to the uplink communication channel employing single carrier frequency domain multiple access (SC-FDMA) embodiments of the invention may also employ OFDMA. In these further embodiments of the invention the time to frequency domain transformer such as the discrete fourier transformer 503 may be replaced by a serial to parallel converter.

In further embodiments of the invention the single time to frequency domain converter may be replaced by a serial to parallel converter followed by at least two separate time to frequency transformers. In these embodiments of the invention the output of each DFTs is mapped to separate clusters or chunks.

The frequency domain output values from the DFT 503 are then passed to the subcarrier mapper 505.

The subcarrier mapper 505 furthermore is configured to receive from the eNB or determine a resource allocation for the UE which defines the sub-carrier mapping described below. The resource allocation comprises information on the number of clusters as well as on the starting points and widths of the clusters in terms of granularity of the resource blocks. The information may in some embodiments of the invention be signalled on scheduling grants contained on physical DL control channel, or it can be signalled with higher layer signalling. A cluster allocation may be related in some embodiments of the invention to UL control signalling and/or the signalling of related cluster allocation.

The receiving or determination of the resource information and/or the mapping allocation for the user equipment is shown in FIG. 8a by step 704.

The sub-carrier mapper 505 receives the frequency domain values and maps these values to the output sub-carriers according a sub-carrier allocation process. The allocated sub-carriers may be in one or multiple clusters, where a cluster covers one or multiple resource blocks. Sub-carrier clusters are separated by one or multiple resource blocks that are not allocated for the particular UE. According to embodiments Of the invention mapping is predetermined or chosen by an eNB scheduler, based on input parameters received from the user equipment previously. These input parameters may comprise the uplink channel quality, and the user equipment buffer size.

The mapping allocation is passed to the user equipment via the downlink connection in the form of scheduling grants or persistent resource allocations. In some embodiments of the invention the some of the mapping allocation may be implicitly defined and not explicitly signalled to the user equipment. For example the downlink related uplink control signalling may create its own cluster allocation.

The apparatus is therefore in some embodiments of the invention configured to receive the cluster allocation signal, and wherein the cluster selection carried out as described below is dependent on the cluster allocation signal.

The cluster allocation signal comprises in embodiments of the invention at least one of a total number of clusters available, a cluster's size, a cluster's placement in terms of a start, end or point within the cluster which defines the frequency of the cluster, and at least one cluster allocated to the apparatus, in other words which cluster can the subcarrier mapper map to.

The cluster allocation is dependent in embodiments of the invention on at least one of a channel type, a channel mix, radio conditions, and the number of apparatus.

The granularity of the mapping allocation is defined by the resource blocks available for communication. Thus a conceptual difference between the invention and the prior art in the form of the 3GPP release 8 apparatus is that there may be multiple sub-carrier clusters allocated to one UE within one transmission time interval (TTI) (which in LTE is equal to a subframe).

In the embodiments of the invention the DFT frequency values are 1-to-1 mapped to the output sub-carriers (or IFFT frequency values). The DFT frequency values may be mapped into multiple sub-carrier clusters in the IFFT input.

In the embodiments of the invention the allocation of the sub-carriers is such that there may be multiple (separate) clusters allocated to one UE within one TTI.

For example if a resource block size is defined as 12 sub-carriers, the IFFT size is 2048 sub-carriers (in other words there are a possible 2048 inputs to the IFFT as described below), and the DFT size is 240 (In other words the DFT produces 240 output values). If the sub-carrier allocation is such that the output of the sub-carrier mapper outputs the DFT values in two clusters, then the DFT frequency values 0 . . . 95 may be mapped to IFFT frequency values 425 . . . 520 and the DFT frequency values 96 . . . 239 may be mapped to values 1001 . . . 1144.

Thus the subcarrier mapper 505 requires knowledge of the number of available clusters, the starting position of clusters (in terms of the resource blocks) and width of the clusters (in terms of resource blocks).

Thus the apparatus can be considered to be configured to receive a first signal, comprising at least one frequency domain value; and map the first signal to a second signal comprising at least two clusters, each cluster comprising a whole number multiple of a first number of sub-carrier values, wherein each first signal value is mapped to one of the at least two clusters and each of the at least one first signal values is mapped to a sub-carrier value of the one of the at least two clusters dependent on a cluster selection. Furthermore first number is 12. In other words 12 sub-carriers equal a cluster.

Each cluster represents at group of contiguous subcarrier values. In other words the sub-division of the cluster is arranged by grouping blocks of sub-carriers so that the sub-carriers define a region of the spectral frequency.

The first number of sub-carrier values can occupy a 180 kHz bandwidth. In other words the cluster mapping is such that it may be used to produce a. backwards compatible system to that currently used in release 8 3GPP standards where each resource block is defined as the sub-carriers with a bandwidth of 180 kHz.

The second signal can be considered to comprise at least 3 clusters in some embodiments of the invention and wherein each first signal value is mapped to at least two non-adjacent of the at least 3 clusters. Thus the mapping is carried out so that non-adjacent clusters of sub-carrier values are mapped to. This enables the possible mapping of different clusters for a single user which are more optimally mapped in terms of avoiding clusters with high noise or interference for a specific user.

The second signal in some embodiments comprises 180 clusters, wherein each first signal value is mapped to at least-two non-adjacent of the at least 3 clusters, wherein the at least two non-adjacent clusters are clusters near the periphery of the spectrum spanned by the whole of the cluster spectrum. As disclosed above this enables more optimal mapping of sub-carriers and also enables some backwards compatibility with 3GPP release 8 which defines 180 resource blocks over the available spectrum designated.

The mapping of the DFT frequency domain symbols to the sub-carriers taking into account the number, size and position of allocated sub-carrier clusters is shown in FIG. 8a by step 705.

The mapped subcarriers are then passed to the inverse fast fourier transformer (IFFT) 507.

The inverse fast fourier transformer (IFFT) 507 receives the mapped sub-carrier elements and also receives at least one padding values and converts the input frequency component values (both from the subcarrier mapper 505 and the padding or null values) back to a timed domain value. DFT In these embodiments of the invention the operation of the DFT subcarrier mapper and IFFT performs an FDMA operation for the uplink communication from the UE to the eNB. Thus for the specific allocation of the sub-carrier mapper the UE transmission is thus mapped to the correct frequency (sub-carriers) and the null values allow other UEs to use corresponding frequencies which have been allocated to the other UEs for their transmission

The inverse fast fourier transformation of the mapped sub-carriers is shown in FIG. 8a by step 707.

In some embodiments of the invention the inverse fast fourier transformer (IFFT) may be replaced by any suitable frequency domain to time domain conversion performing inverse discrete fourier transform operation.

The time domain output from the inverse fast fourier transformer 507 is them passed to the cyclic prefix inserter 509.

The cyclic prefix inserter on receiving the time domain signal adds a cyclic prefix to the time domain signal. The cyclic prefix insertion process used may be any suitable cyclic prefix insertion process.

The cyclic prefix insertion is shown in FIG. 8a by step 709.

The user equipment may then, using the radio frequency circuitry 7, perform a digital to analogue conversion on the output of the cyclic inserter 509. Furthermore prior to transmission the user equipment radio frequency circuitry may perform a baseband to radio frequency conversion prior to transmitting the signal.

The digital to analogue conversion and the baseband to radio frequency conversion operation's are shown in FIG. 8a by step 711.

FIG. 5b shows a schematic view of a series of functional blocks used in embodiments of the invention with respect to an embodiment of the invention implemented in an uplink receiver. The functional blocks described below may be implemented within the processing entity 167 of an enhanced node B 151 such as that shown in FIG. 3. It would be understood that the functional blocks described hereafter may be implemented as discrete functional units within the enhanced node B 151 in further embodiments of the invention. The operation of the enhanced node B is described with respect to an operation of an embodiment of the invention in FIG. 8b.

The enhanced node B 151 radio access transceiver 163 may comprises a radio frequency to baseband converter and analogue to digital converter 163. The radio frequency to baseband converter and analogue to digital converter performs the opposite operations to the user equipment radio frequency circuitry 7, converting the received analogue radio frequency signals to produce a baseband and digital output signal.

The baseband and digital output signal may then be passed to the eNB processor 167 and a cyclic prefix remover 551.

The reception of the analogue radio frequency signal is shown in FIG. 8b by step 751.

The analogue to digital conversion and the radio frequency to baseband frequency conversion is shown in FIG. 8b by step 753.

The cyclic prefix remover performs the inverse operation as applied by the user equipment cyclic prefix inserter 509.

The output of the cyclic prefix remover is passed to the discrete fourier transformer 553.

The cyclic prefix removal is shown in FIG. 8b by step 755.

The discrete fourier transformer converts the time domain output from cyclic prefix remover into a frequency domain signal. The converter used is the reciprocal conversion to that applied in the inverse fast fourier transformer 507.

The output of the discrete fourier transformer 553 is passed to the sub-carrier demapper 555.

The discrete fourier transformation of the output of the cyclic prefix remover 551 is shown in FIG. 8b by step 757,

The sub-carrier demapper 555 is configured to determine or retrieve from memory 169 the allocated resource allocation for the UE from which the signal has been received. The resource allocation may comprise explicit sub-carrier mapping values or the demapper may further determine the sub-carrier mapping values using predetermined algorithms or from the memory 169.

Thus in embodiments of the invention there are apparatus configured to determine a cluster allocation signal, and transmit the cluster allocation signal to a further apparatus.

The cluster allocation signal comprises in embodiments of the invention at least one of, a total number of clusters, a cluster size, a cluster placement and at least one cluster allocated to the first signal.

The cluster allocation signal may be considered to further be dependent on at least one of a type of communications channel from the further apparatus to the apparatus; a determination of the mixture of the data to be transmitted on a communications channel from the further apparatus to the apparatus; and a radio condition of a communications channel from the further apparatus to the apparatus.

The resource allocation may comprise information on the number of clusters as well as on the starting points and widths of the clusters in terms of granularity of the resource blocks allocated to the user equipment from which the signal has been received. The information may in some embodiments of the invention be stored in memory 169 in the form of scheduling grants.

The sub-carrier demapper 555 receives the frequency domain sub-carrier values and maps these sub-carrier values to the output frequency domain values according to reciprocal mapping process as carried out by the sub-carrier mapper 505 of the user equipment 1.

Thus in this situation the apparatus is configured to map a first signal to a second signal comprising at least one frequency domain value, wherein the first signal comprises at least two clusters, at least one cluster comprising a whole number multiple of a first number of sub-carrier values, wherein the at least one cluster sub-carrier values are mapped to the at least one frequency domain values dependent on a cluster selection.

Using the example presented previously where a resource block size is defined as 12 sub-carriers, the DFT size is 2048 sub-carriers (in other words there are a possible 2048 outputs from the DFT), and the IFFT size is 240 (in other words the IFFT input from the output of the demapper 555 produces 240 output values). If the sub-carrier allocation was that the output of the sub-carrier mapper outputs the DFT values in two clusters, then the DFT frequency values 425 . . . 520 may be demapped to IFFT frequency values 0 . . . 95 and the DFT frequency values 1001 . . . 1144 may be demapped to values 96 . . . 239.

Thus the subcarrier de-mapper 555 also requires the knowledge of the number of available clusters, the starting position of clusters (in terms of the resource blocks) and width of the clusters (in terms of resource blocks).

The mapping of the OFT sub-carrier frequency domain values to the frequency domain received symbol values taking into account the number, size and position of allocated sub-carrier clusters is shown in FIG. 8b by step 759.

The sub-carrier de-mapper 555 outputs the de-mapped frequency domain received symbol values to the inverse fast fourier transformer (IFFT) 557. The IFFT 557 performs a frequency to time domain transformation which is the reciprocal action to that performed by the discrete fourier transformer 503 in the user equipment 1.

The time domain received symbol values are then passed to the detector 559.

The inverse fast fourier transformation is shown in FIG. 8b by step 761.

The detector 559 then performs a symbol detection wherein the time domain symbol value is used to determine an estimate of the originally encoded symbol and furthermore output a sequence of bit values dependent on the estimated symbol value.

The detection of the received symbol is shown in FIG. 8b by step 763.

In the equivalent further embodiments of the invention, the DFT and IFFT converters may replace the DFT by a serial to parallel converter and the IFFT by the reciprocal parallel to serial converter.

With respect to FIGS. 6 and 7 the advantages introduced by embodiments of the invention can be shown.

With respect to FIG. 6, the cubic metric comparison between the single carrier (SC-FDMA), enhanced single carrier. (E-SC-FDMA) and conventional multicarrier-frequency division (OFDMA) methods are shown. The single carrier method is represented by limiting the E-SC-FDMA to a single cluster.

Furthermore the comparison of cubic metric for the access technologies is shown for simulations using the modulation schemes of QPSK, 16-QAM and 64-QAM.

In FIG. 6, it can be clearly shown that the lowest cubic metric value for each of the three modulation schemes occurs using the SC-FDMA process (in other words the E-SC-FDMA using only one cluster) and the highest cubic metric value for each modulation scheme occurs using the OFDMA process. The enhanced single carrier E-SC-FDMA process for 2, 4, 8 and 16 clusters shows an increase in cubic metric as the number of clusters is increased.

Thus it can be shown that with two clusters it is possible to have a lower output back off (OBO) at the power amplifier of about 1.0 to 1.7 dB than the equivalent OFDM approach. With four clusters it is possible to produce about 0.8 to 1.0 dB lower OBO than OFDM. With eight clusters it is possible to produce between 0.4 and 0.8 dB lower OBO than OFDM. Furthermore with sixteen clusters, it is possible to produce about 0.3 to 0.4 dB lower OBOs than OFDM.

With respect to FIG. 7, The estimated throughput gain of OFDMA and E-SC-FDMA is shown when compared against SC-FDMA. Throughput gains are shown on the graph for various numbers of user equipment at three signal to noise ratio points in an indoor office non line of sight (NLoS) channel. The results according to FIG. 7 show that the E-SC-FDMA process is able to produce a significant proportion of the OFDMA gain but use only two clusters.

With the relative difference decreasing between the enhanced single carrier frequency division multiple access (E-SC-FDMA) technique and the orthogonal frequency division multiple access (OFDMA) technique as the number of user equipment used is increased.

Thus the above show that the E-SC-FDMA techniques are capable of producing close to the throughput of the conventional OFDMA techniques but have much lower cubic metric values. Furthermore by having the flexibility to operate for a range of clusters it is possible to operate flexibly according to the environmental conditions—number of clusters available, channel noise and interference and according to the data requirements.

It is noted that whilst embodiments have been described in relation to mobile devices such as mobile terminals, embodiments of the present invention are applicable to any other suitable type of apparatus suitable for communication via access systems. A mobile device may be configured to enable use of different access technologies, for example, based on an appropriate multi-radio implementation.

It is also noted that although certain embodiments were described above by way of example with reference to the exemplifying architectures of certain mobile networks and a wireless local area network, embodiments may be applied to any other suitable forms of communication systems than those illustrated and described herein. It is also noted that the term access system is understood to refer to any access system configured for enabling wireless communication for user accessing applications.

The above described operations may require data processing in the various entities. The data processing may be provided by means of one or more data processors. Similarly various entities described in the above embodiments may be implemented within a single or a plurality of data processing entities and/or data processors. Appropriately adapted computer program code product may be used for implementing the embodiments, when loaded to a computer. The program code product for providing the operation may be stored on and provided by means of a carrier medium such as a carrier disc, card or tape. A possibility is to download the program code product via a data network. Implementation may be provided with appropriate software in a server.

For example the embodiments of the invention may be implemented as a chipset, in other words a series of integrated circuits communicating among each other. The chipset may comprise microprocessors arranged to run code, application specific integrated circuits (ASICs), or programmable digital signal processors for performing the operations described above.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

It is also noted herein that while the above describes exemplifying embodiments of the invention, there are several variations and modifications which may be made to the disclosed solution without departing from the scope of the present invention.

1. Apparatus configured to:
receive a first signal comprising at least one frequency domain value;
map the first signal to a second signal comprising at least two clusters, each cluster comprising a whole number multiple of a first number of sub-carrier values, wherein each first signal value is mapped to one of the at least two clusters and each of the at least one first signal values is mapped to a sub-carrier value of the one of the at least two clusters dependent on a cluster selection.

2. The apparatus as claimed in claim 1, wherein the first number is 12.

3. The apparatus as claimed in claim 1, wherein each cluster represents at group of contiguous subcarrier values.

4. The apparatus as claimed in claim 1, wherein the first number of sub-carrier values occupy a 180 kHz bandwidth.

5. The apparatus as claimed in claim 1, wherein the second signal comprises at least 3 clusters, wherein each first signal value is mapped to at least two non-adjacent of the at least 3 clusters.

6. The apparatus as claimed in claim 1, wherein the second signal comprises 180 clusters, wherein each first signal value is mapped to at least-two non-adjacent of the 180 clusters, wherein the at least two non-adjacent clusters are clusters near the periphery of the spectrum spanned by the whole of the cluster spectrum.

7. The apparatus as claimed in claim 1, wherein the apparatus is further configured to receive a cluster allocation signal, and wherein the cluster selection is dependent on the cluster allocation signal.

8. The apparatus as claimed in claim 7 wherein the cluster allocation signal comprises at least one of:
a total number of clusters,
a cluster size;
a cluster placement;
at least one cluster allocated to the apparatus.

9. The apparatus as claimed in claim 7, wherein the cluster allocation is dependent on at least one of: a channel type; a channel mix; a radio conditions; the number of apparatus.

10. The apparatus as claimed in claim 1, wherein the first signal comprises a plurality of processed symbol values, wherein the process comprises at least one of:
a serial to parallel conversion;
a time to frequency domain conversion.

11. The apparatus as claimed in claim 1, further configured to transform the second signal to a third signal, wherein the third signal is a time domain signal and ail of the at least two clusters are transformed to form the third signal.

12. The apparatus as claimed in claim 11, further configured to transmit the third signal.

13. Apparatus configured to:
map a first signal to a second signal comprising at least one frequency domain value, wherein the first signal comprises at least two clusters, at least one cluster comprising a whole number multiple of a first number of sub-carrier values, wherein the at least one cluster sub-carrier values are mapped to the at least one frequency domain values dependent on a cluster selection.

14. The apparatus as claimed in claim 13, wherein the first number is 12.

15. The apparatus as claimed in claim 13, wherein each cluster represents at group of contiguous subcarrier values.

16. The apparatus as claimed in claim 13, wherein the first signal comprises at least 3 clusters, wherein at least two non-adjacent cluster sub-carrier values are mapped to the at least one frequency domain values.

17. The apparatus as claimed in claim 13, wherein the first signal comprises 180 clusters, wherein at least two non-adjacent cluster sub-carrier values are mapped to the at least one frequency domain values, wherein the at least two non-adjacent clusters are clusters near the periphery of the spectrum spanned by the whole of the cluster spectrum.

18. The apparatus as claimed in claim 13, wherein the apparatus is further configured to determine a cluster allocation signal, and wherein the cluster selection is dependent on the cluster allocation signal.

19. The apparatus as claimed in claim 18 wherein the cluster allocation signal comprises at least one of:
a total number of clusters,
a cluster size;
a cluster placement;
at least one cluster allocated to the first signal.

20. The apparatus as claimed in claim 18, wherein the cluster allocation signal is dependent on at least one of:
a channel type;
a channel mix;
a radio condition,

21. The apparatus as claimed in claim 13, further configured to process the second signal, wherein the process is configured to be at least one of:
a serial to parallel conversion;
a time to frequency domain conversion;
a parallel to serial conversion; and
a frequency to time domain conversion.

22. The apparatus as claimed in claim 13, further configured to receive a third signal, wherein the apparatus is configured to transform the third signal to generate the first signal, wherein the third signal is a time domain signal.

23. An apparatus configured to:
determine a cluster allocation signal, and
transmit the cluster allocation signal to a further apparatus.

24. The apparatus as claimed in claim 23 wherein the cluster allocation signal comprises at least one of:
a total number of clusters,
a cluster size;
a cluster placement;
at least one cluster allocated to the first signal.

25. The apparatus as claimed in claim 23, wherein the cluster allocation signal is dependent on at least one of:
a type of communications channel from the further apparatus to the apparatus;
a determination of the mixture of the data to be transmitted on a communications channel from the further apparatus to the apparatus;
a radio condition of a communications channel from the further apparatus to the apparatus.

26. A method comprising:
receiving a first signal comprising at least one frequency domain value;
mapping the first signal to a second signal comprising at least two clusters, each cluster comprising a whole number multiple of a first number of sub-carrier values, wherein each first signal value is mapped to one of the at least two clusters and each of the at least one first signal values is mapped to a sub-carrier value of the one of the at least two clusters dependent on a cluster selection.

27. The method as claimed in claim 26, wherein the first number is 12.

28. The method as claimed in claim 26, wherein each cluster represents at group of contiguous subcarrier values.

29. The method as claimed in claim 26, wherein the first number of sub-carrier values occupy a 180 kHz bandwidth.

30. The method as claimed in claim 26 wherein the second signal comprises at least 3 clusters, wherein each first signal value is mapped to at least two non-adjacent of the at least 3 clusters.

31. The method as claimed in claim 26, wherein the second signal comprises 180 clusters, wherein each first signal value is mapped to at least-two non-adjacent of the 180 clusters, and the at least two non-adjacent clusters are clusters near the periphery of the spectrum spanned by the whole of the cluster spectrum.

32. The method as claimed in claim 26, further comprising receiving a cluster allocation signal, and wherein the cluster selection is dependent on the cluster allocation signal.

33. The method as claimed in claim 32 wherein the cluster allocation signal comprises at least one of:
a total number of clusters,
a cluster size;
a cluster placement;
at least one cluster allocated to the apparatus.

34. The method as claimed in claim 32, wherein the cluster allocation is dependent on at least one of:
a channel type;
a channel mix;
a radio conditions;
the number of apparatus.

35. The method as claimed in claim 26, wherein the first signal comprises a plurality of processed symbol values, wherein the process comprises at least one of: a serial to parallel conversion; a time to frequency domain conversion.

36. The method as claimed in claim 26, further comprising transforming the second signal to a third signal, wherein the third signal is a time domain signal and all of the at least two clusters are transformed to form the third signal.

37. The method as claimed in claim 36, further comprising transmitting the third signal.

38. A method comprising:
mapping a first signal to a second signal comprising at least one frequency domain value, wherein the first signal comprises at least two clusters, at least one cluster comprising a whole number multiple of a first number of sub-carrier values, wherein the at least one cluster sub-carrier values are mapped to the at least one frequency domain values dependent on a cluster selection.

39. The method as claimed in claim 38, wherein the first number is 12.

40. The method as claimed in claim 38, wherein each cluster represents at group of contiguous subcarrier values.

41. The method as claimed in claim 38, wherein the first signal comprises at least 3 clusters, wherein at least two non-adjacent cluster sub-carrier values are mapped to the at least one frequency domain values.

42. The method as claimed in claim 38, wherein the first signal comprises 180 clusters, wherein at least two non-adjacent cluster sub-carrier values are mapped to the at least one frequency domain values, and wherein the at least two non-adjacent clusters are clusters near the periphery of the spectrum spanned by the whole of the cluster spectrum.

43. The method as claimed in claim 38, further comprising determining a cluster allocation signal, and wherein the cluster selection is dependent on the cluster allocation signal.

44. The method as claimed in claim 43 wherein the cluster allocation signal comprises at least one of:
a total number of clusters,
a cluster size;
a cluster placement;
at least one cluster allocated to the first signal.

45. The method as claimed in claim 43, wherein the cluster allocation signal is dependent on at least one of: a channel type; a channel mix; a radio condition, and wherein the cluster allocation signal comprises at least one of: a total number of clusters, a cluster size; a cluster placement;
at least one cluster allocated to the first signal.

46. The method as claimed in claim 38, further comprising processing the second signal, wherein the processing comprises at least one of;
a serial to parallel conversion;
a time to frequency domain conversion;
a parallel to serial conversion; and
a frequency to time domain conversion.

47. The method as claimed in claim 38, further comprising receiving a third signal, wherein the method comprises transforming the third signal to generate the first signal, and wherein the third signal is a time domain signal.

48. A method comprising:
determining a cluster allocation signal, and
transmitting the cluster allocation signal to an apparatus.

49. The method as claimed in claim 48 wherein the cluster allocation signal comprises at least one of:
a total number of clusters,
a cluster size;
a cluster placement;
at least one cluster allocated to the first signal.

50. The apparatus as claimed in claim 48, wherein the cluster allocation signal is dependent on at least one of: a type of communications channel from the further apparatus to the apparatus; a determination of the mixture of the data to be transmitted on a communications channel from the further apparatus to the apparatus;
a radio condition of a communications channel from the further apparatus to the apparatus, and the cluster allocation signal comprises at least one of: a total number of clusters, a cluster size; a cluster placement; at least one cluster allocated to the first signal.

51. A computer program product configured to perform a method comprising;
receiving a first signal comprising at least one frequency domain value;
mapping the first signal to a second signal comprising at least two clusters, each cluster comprising a whole number multiple of a first number of sub-carrier values, wherein each first signal value is mapped to one of the at least two clusters and each of the at least one first signal values is mapped to a sub-carrier value of the one of the at least two clusters dependent on a cluster selection.

52. A computer program product configured to perform a method comprising:
mapping a first signal to a second signal comprising at least one frequency domain value, wherein the first signal comprises at least two clusters, at least one cluster comprising a whole number multiple of a first number of sub-carrier values, wherein the at least one cluster sub-carrier values are mapped to the at least one frequency domain values dependent on a cluster selection.

53. A computer program product configured to perform a method comprising:
determining a cluster allocation signal, and
transmitting the cluster allocation signal to an apparatus.

54. An apparatus comprising:
means for receiving a first signal comprising at least one frequency domain value;
and means for mapping the first signal to a second signal comprising at least two clusters, each cluster comprising a whole number multiple of a first number of sub-carrier values, wherein each first signal value is mapped to one of the at least two clusters and each of the at least one first signal values is mapped to a sub-carrier value of the one of the at least two clusters dependent on a cluster selection.

55. Apparatus comprising:
means for mapping a first signal to a second signal comprising at least one frequency domain value, wherein the first signal comprises at least two clusters, at least one cluster comprising a whole number multiple of a first number of sub-carrier values, wherein the at least one cluster sub-carrier values are mapped to the at least one frequency domain values dependent on a cluster selection.

56. Apparatus comprising:
means for determining a cluster allocation signal, and
means for transmitting the cluster allocation signal to an apparatus.

57. The apparatus of claim 1, comprising a user equipment.

58. The apparatus as claimed in claim 13, comprising at least one of:
a base transceiver station (BTS) for providing access in a GSM network;
a node B (node B) for providing access in a UTRA network; and
an evolved node B (node) for providing access in an EUTRA network.
